(19) United States
(12) Patent Application Publication
(10) Pub. No.: US 2007/0070898 A1
(43) Pub. Date: Mar. 29, 2007

(54) Channel resource allocation based upon call blocking probabilities

(76) Inventor: Nidal N. Khrais, Flanders, NJ (US)

Correspondence Address: CARLSON, GASKEY & OLDS, P.C., 400 W MAPLE RD, SUITE 350, BIRMINGHAM, MI, 48009, US

(21) Appl. No.: 11/238,840

(22) Filed: Sep. 29, 2005

(51) Int. Cl. H04L 12/26

(52) U.S. Cl. 370/230; 370/252

(57) ABSTRACT

A channel resource (50) allocation technique includes maintaining a probability of blocking a call for a call class within desired limits. A channel resource allocation module (38) determines a current probability of blocking a call of at least one class based upon current traffic for at least that class and a current resource allocation. A disclosed example includes using an ATM network and automatically adjusting CID resource allocations on a PVC to increase the allocation for that class if the current probability exceeds a desired probability. A disclosed example includes maintaining different probabilities for different classes with different priorities.

### FIELD OF THE INVENTION

This invention generally relates to telecommunications. More particularly, this invention relates to channel resource allocation in communication systems.

### DESCRIPTION OF THE RELATED ART

Wireless communication systems allow mobile stations such as cell phones to communicate with remotely located devices. The wireless communication system typically includes a plurality of base stations geographically situated to provide wireless communication coverage in appropriate areas. Communications between the mobile stations and the base station are wireless.

The base stations communicate with a core network. A radio network controller typically handles communications from a base station and directs them to the core network for appropriate processing. Communications between the base station and the radio network controller typically occur over a physical link. A physical link can have one or more virtual paths and a virtual path can include one or more virtual channels. Each virtual channel may handle more than one type of communication. A permanent virtual channel (PVC) is one example connection type between two nodes such as a base station and a radio network controller.

Traffic management along PVC's is often based on a first come, first served approach. There are several drawbacks to this technique. One is that it does not recognize or accommodate differences between different types of calls or services. For example, voice communications typically have different quality of service requirements than data communications. Each type of communication has a unique and different quality of service characteristic, which indicates the amount of acceptable delay and jitter, for example. Additionally, call admission requirements vary among different classes of communications.

Another drawback to the first come, first served approach is that it does not allow a service provider to dictate or control the use of resources. It is desirable, for example, for a service provider to have some freedom in controlling the types of calls that are admitted based upon projections of different revenues that each service type might bring.

There is a need for an improved technique for allocating channel resources to provide better call admission. This invention addresses that need.

### SUMMARY OF THE INVENTION

An exemplary disclosed method of communicating includes automatically adjusting an allocation of a channel resource among a plurality of call classes to maintain a probability of blocking a call belonging to at least one of the call classes within a desired range.

In one example, the channel comprises a permanent virtual channel, the resources comprise channel ID (CID) units, which correspond to the minimum bandwidth available on the channel and the network comprises an asynchronous transfer mode (ATM) network.

By maintaining the probability of blocking a call for a particular class below a selected threshold, the channel resource allocation ensures that the channel resources accommodate at least one call class within desired limits. In one example, the channel resources are allocated in a manner that maintains a plurality of probabilities of blocking a call belonging to any of a corresponding plurality of call classes within corresponding desired ranges. Any shifting of allocations among the call classes includes maintaining the probability of blocking a call from any of the classes within an acceptable range.

One example includes dividing a channel resource into at least two parts. The first one of the parts is partitioned in a “complete partitioning” manner such that at least one partition of the first part is allocated to each of the call classes expected on that channel. A second part of the channel resource is shared among the plurality of classes.

One example includes directing calls of a particular class to the partition of the first part allocated for that class. If that partition is busy, the call of the corresponding class may be directed to the second part, which is shared among the plurality of classes.

One example includes moving boundaries between the partitions of the first part as necessary to accommodate the desired probabilities of blocking calls. In one example, when the traffic volume is high enough, a boundary between the first part and the second part can be moved to allocate more resources to the first part to accommodate the higher traffic volumes.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows selected portions of a wireless communication network including an embodiment of this invention.

FIG. 2 is a flowchart diagram summarizing one example approach designed according to an embodiment of this invention.

FIG. 3 schematically shows a channel resource allocation according to one embodiment.

### DETAILED DESCRIPTION

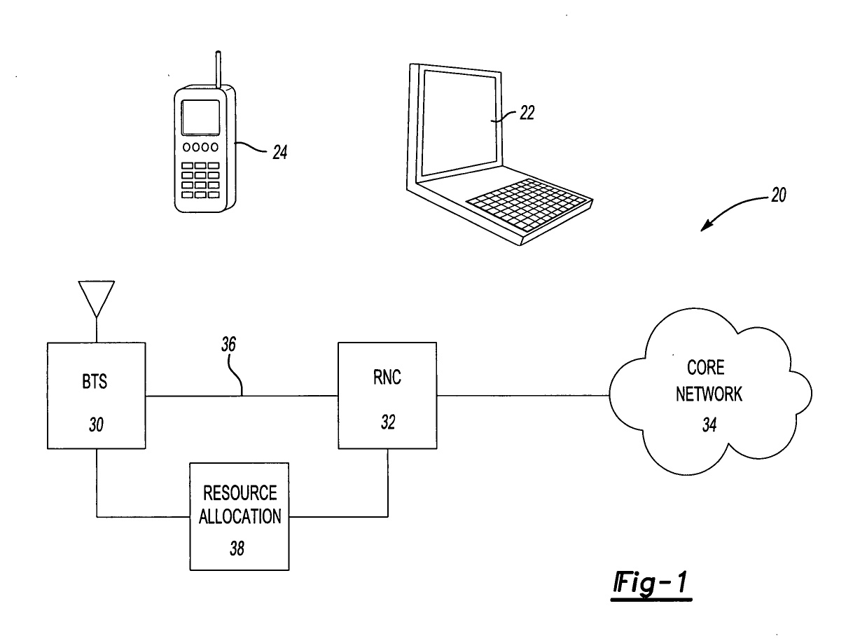

FIG. 1 schematically shows selected portions of a wireless communication system 20. Mobile stations 22 and 24 communicate over wireless links with a base station 30. At least one network device communicates directly with the base station 30. The illustrated example includes a radio network controller (RNC) 32 that communicates with the base station 30 and a core network 34. A physical link 36 between the base station 30 and the RNC 32 is established in a known manner. In one example, the physical link 36 includes at least one permanent virtual channel (PVC) over which various types of communications are carried between the base station 30 and the radio network controller 32. The illustrated example uses asynchronous transfer mode (ATM) transport technology over the PVC.

The example of FIG. 1 includes a resource allocation module 38 that controls how the physical link channel resources are allocated among the different services or call types communicated between the base station 30 and the RNC 32. For discussion purposes, the different types of services or calls will be referred to as different call classes in this description. The resource allocation module 38 automatically adjusts allocations of the channel resource among the different call classes to ensure a quality of service for each call class or to provide higher priority to one class compared to another, depending on the needs of a particular situation.

For discussion purposes, a PVC will be used as an example channel and channel ID (CID) units, which correspond to the minimum unit of bandwidth available, will be used as example channel resources. In one example, the minimum bandwidth allocation on the channel 36 is 2 Kb/s (i.e., one CID corresponds to 2 Kb/s). The use of CID units within ATM networks is known.

The resource allocation module is schematically shown as a separate component or software program but it may be incorporated into the base station 30 or the RNC 32, for example.

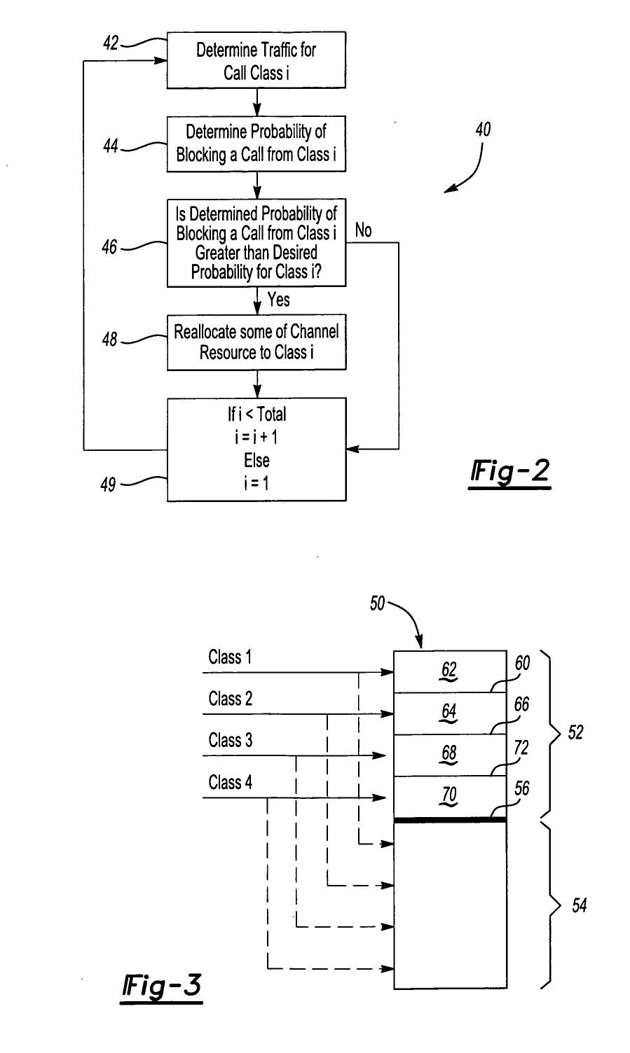

One example technique is summarized in the flow chart diagram 40 of FIG. 2. At 42, the resource allocation module 38 determines a traffic volume for a call class i. Known techniques are used to accomplish this in one example. Based upon the different types of services associated with each call class, the resource allocation module 38 is provided with expected or desired probabilities of blocking a call for a particular call class to provide a desired level of service for a corresponding type of call. Given the current amount of traffic on the PVC and a current allocation of the PVC resource to the call class i, the resource allocation module 38 determines a current probability of blocking a new call from class i at 44.

At 46, the resource allocation module 38 determines whether the determined probability from 44 is greater than the desired probability for blocking a new call belonging to class i. In the event that the actual probability is greater than the desired probability, the resource allocation module 38 redistributes or automatically adjusts allocations of the PVC resource at 48 to reallocate some additional portion of the resource to the call class i. In the event that the determined probability at 46 is within a desired range of the desired probability, no adjustment of the channel resource allocation need be made.

The technique for determining what a desired probability of blocking a call will be may vary depending on the needs of a particular situation. Those skilled in the art who have the benefit of this description will realize how to determine appropriate probabilities for particular call classes for their particular situation.

The example of FIG. 2 includes a step 49 that schematically illustrates how the process includes analyzing the probability of blocking a call for each call class associated with a particular channel.

Given the number of call classes to be serviced on a channel (i.e., a PVC) and the relative priorities between them (i.e., the desired probabilities of blocking a call for each class), a channel resource can be divided up to accommodate the different call classes within a desired range of the desired probabilities. FIG. 3 schematically shows an example PVC resource 50 that is divided into a first part 52 and a second part 54. A boundary 56 between the first part 52 and the second part 54 establishes the amount of channel resource (e.g., CID units) allocated to each part.

In this example, the first part 52 is allocated using a complete partitioning approach such that the first part 52 is divided up into specific partitions that are then each allocated to a specific call class. In one example, the second part 54 is utilized in a complete sharing manner such that the resources of the second part 54 are shared among the different call classes as needed.

In one example, any new call from a particular call class is first directed to the appropriate partition within the first part 52. In the event that the traffic volume and the current allocation is insufficient to handle the new call, it may be directed to the second part 54. This is schematically shown in FIG. 3 by the dashed lines.

In the example of FIG. 3, the first part 52 includes a first a boundary 60 between a first partition 62 and a second partition 64. A first call class is allocated the first partition 62 while a second call class is allocated the second partition 64. Another boundary 66 separates the second partition 64 from a third partition 68. A fourth partition 70 in this example is separated from the third partition 68 by a boundary 72.

The resource allocation module 38 utilizes the current traffic volumes, the desired probabilities of blocking a call for each class and the total channel resource for strategically setting the boundaries 60, 66 and 72 within the first part 52 to maintain the probability of blocking a call for any of the call classes within a desired range. In one example, a maximum desired probability for each class is set and the resource allocation module 38 ideally maintains actual probabilities of blocking a call below that maximum as often as possible. Depending on the nature of the different call classes, different probabilities for each may be set. Moving the boundaries within the first part 52 responsive to varying traffic volumes based upon desired probabilities of blocking a new call provides a dynamic adjustment of channel resources that better utilizes the resource compared to a first come, first served approach.

In one example, the resource allocation module 38 analyzes the channel resource in terms of CID units. For example, a voice service requires a bandwidth of 18 Kb/s and a 64 Kb/s data service requires an 80 Kb/s bandwidth. In this example, the equivalent CID unit is 2 kb/s such that each voice call requires 9 CID units and each 64 Kb/s data call requires 40 CID units. The resource allocation module 38 in one example attempts to set the boundaries 60, 66 and 72 to provide enough CID units within each partition to maintain the probability of blocking a new call from each class within the corresponding range for each class.

Within the first part 52 of the example of FIG. 3, each partition 62, 64, 68 and 70 has a total number of allocated CID units. One chain of the CID units for each class type will be busy when they are being used for a current, active call. Another chain within each partition can be considered free CID units for that class type because they are currently idle. The number of CID units in each chain will vary with varying traffic volumes on the channel for each call class.

In one example, the second part 54 uses a complete sharing approach such that there is one chain of allocated or busy CID units and a chain of free or available CID units within the second part 54.

When a new call is received, the resource allocation module 38 determines the number of required CID units for handling that call. The resource allocation module 38 also determines whether the chain of free CID units from the corresponding partition in the first part 52 is sufficient to handle that call. The number of free CID units and the required number to handle a new call provides the resource allocation module 38 with enough information to determine a current probability of blocking a new call. Although the corresponding partition within the first part 52 may not have enough free CID units, the second part 54 may and the call may be directed to the second part 54. If the required number of CID units for that particular call type is not available in the chain of free CID units in either the corresponding partition of the first part 52 or the second part 54, the call will be blocked. The resource allocation module 38 in this example adjusts the allocation of the channel resource (i.e., moves at least one of the boundaries) to prevent a call from being blocked when possible.

The resource allocation module 38 in one example reallocates resources from a call class that is experiencing a relatively lower traffic volume to another call class that is currently experiencing a relatively higher traffic volume. In other words, the call class having the largest probability of blocking a call receives more of the channel resource within its partition to handle the increased traffic volume. In one example, such resource reallocation includes maintaining the probability of blocking a call within the desired limits for all call classes as much as possible. In other words, moving one of the boundaries within the first part 52 in one example does not include moving a boundary in a manner that increases a probability of blocking a call for a call class that is giving up resources such that the corresponding probability exceeds the desired probability for the less busy call class. An existing allocation of the channel resource may be maintained without adjusting any boundaries whenever all call class probabilities are within a desired range.

One example includes moving the boundary 56 between the first part 52 and the second part 54 as may be needed to accommodate heavy traffic volumes. In one example, whenever n call classes currently have arriving traffic at the base station 30, for example, and more than n/2 call classes have a high probability of blocking a new call that is above the pre-specified desired probability, the resource allocation module 38 allocates some of the second part 54 to the first part 52. In one example, 25% of the resource currently allocated to the second part 54 is reallocated to the first part 52 and that resource is distributed among the example partitions as needed to establish acceptable probabilities for the different call classes.

Using information regarding types of calls, traffic volumes for each and desired probabilities for blocking calls from each class as described in the above examples provides better use of channel resources among different call classes. The disclosed example technique including moving boundaries between different partitions of a channel resource provides the advantage of enhancing the ability to meet quality of service requirements for different call classes. Additionally, there is freedom in controlling the types of calls that will be admitted based upon a customer's desires. For example, higher priority can be given to services that result in higher revenues so that service providers can maximize the use of channel resources to their advantage.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A method of communicating, comprising:
automatically adjusting an allocation of a channel resource among a plurality of call classes to maintain a probability of blocking a call belonging to at least one of the call classes within a desired range.

2. The method of claim 1, wherein the channel comprises a permanent virtual channel.

3. The method of claim 1, comprising maintaining the probability below a selected threshold.

4. The method of claim 1, comprising automatically adjusting the allocation of the channel resource to maintain a plurality of probabilities of blocking a call belonging to any of a corresponding plurality of the call classes within a desired range.

5. The method of claim 1, comprising allocating some of the channel resource currently allocated to a first one of the call classes having a current probability within a first desired range to a second one of the call classes having a current probability near a limit of a second desired range.

6. The method of claim 5, comprising maintaining different probabilities for different ones of the classes.

7. The method of claim 1, comprising
dividing up the channel resource into at least two parts;
partitioning a first one of the parts among the plurality of call classes such that at least one partition of the first part is allocated to each of the call classes; and
sharing a second one of the two parts among the plurality of classes.

8. The method of claim 7, comprising
establishing boundaries within the first part that establish a size of each partition; and
automatically moving at least one of the boundaries to change the size of at least two of the partitions to thereby adjust the allocation of the channel resource.

9. The method of claim 7, comprising
directing a call to the first part of the channel resource if the partition of the first part for the corresponding call class has capacity to handle the call; and
directing the call to the second part of the channel resource if the partition of the first part for the corresponding call class has insufficient capacity to handle the call.

10. The method of claim 7, comprising partitioning the first part such that different ones of the call classes have different allocations of the resource.

11. The method of claim 7, comprising:
determining a number of the call classes having a probability outside of the desired range; and
allocating at least some of the second part to the first part if the determined number is above a selected number.

12. The method of claim 11, comprising:
determining a number of call classes including arriving calls;
determining a percentage of the call classes including arriving calls that have a probability of blocking a call that is outside of the desired range; and
allocating at least some of the second part to the first part if the determined percentage is above a selected percentage.

13. The method of claim 12, wherein the selected percentage is 50% and including allocating at least 25% of the second part to the first part.

14. The method of claim 1, comprising
determining an amount of traffic for the at least one call class;
determining a current channel resource allocation for the at least one call class; and
determining a probability that another call of the at least one class will be blocked based on the current channel resource allocation.

15. The method of claim 14, comprising
determining whether the determined probability is greater than a desired probability of blocking a call belonging to the at least one class; and
increasing the allocation for the at least one class if the determined probability is greater than the desired probability.

16. The method of claim 15, comprising
determining a second probability that a call belonging to a second one of the call classes will be blocked based on a current channel resource allocation for the second call class;
reallocating some of the resource allocation for the second class to the at least one class if the determined second probability is within a corresponding desired range.

17. The method of claim 16, comprising
determining an amount of the channel resource required for the second probability to remain within the desired range; and
maintaining at least the determined amount of the channel resource allocation for the second class when reallocating some of the resource to the at least one class.

18. The method of claim 1, wherein a first one of the call classes has a higher priority than at least a second one of the call classes and comprising allocating more of the channel resource to the first call class than to the second call class.

19. The method of claim 1, wherein the channel resource comprises channel ID units.

20. The method of claim 1, comprising using asynchronous transfer mode communication on the channel.
